(19) United States
(12) Patent Application Publication
(10) Pub. No.: US 2017/0064405 A1
(43) Pub. Date: Mar. 2, 2017

(54) SYSTEM AND METHOD FOR PERSONALIZING AND RECOMMENDING CONTENT

(71) Applicant: Caavo Inc, Santa Clara, CA (US)

(72) Inventors: Andrew E. Einaudi, San Francisco, CA (US); Ashish D. Aggarwal, Stevenson Ranch, CA (US)

(21) Appl. No.: 15/248,978

(22) Filed: Aug. 26, 2016

Related U.S. Application Data
(60) Provisional application No. 62/210,127, filed on Aug. 26, 2015.

(51) Int. Cl. H04N 21/482; G06F 17/30; H04N 21/84; H04N 21/466; H04N 21/258; H04N 21/45; H04L 29/08; H04N 21/25

(52) U.S. Cl. CPC H04N 21/4826; H04L 67/306; H04L 67/22; G06F 17/30702; H04N 21/251; H04N 21/4668; H04N 21/4667; H04N 21/25891; H04N 21/4532; H04N 21/84

(57) ABSTRACT

Methods, systems, and apparatuses are described for personalizing and recommending content. Media or multimedia activity of users, or consumed media or multimedia content, is automatically detected or observed, and a temporal identifier associated with the activity is determined. A usage profile is created for the users based on the activity and the temporal identifier. The usage profile is stored and may be updated based on additional detections or observations. Recommendations for additional content are automatically performed based on the usage profile. Recommendations for additional content may be based on periodic content releases or activities, content that is part of a series, content comprising sequels, or additional content that is similar or associated with consumed content.

### CROSS-REFERENCE TO RELATED APPLICATIONS

The instant application claims priority to U.S. Provisional Patent Application No. 62/210,127, entitled “Method and Implementation of Personalizing and Recommending Content,” filed on Aug. 26, 2015, the entirety of which is incorporated by reference herein.

This application is related to U.S. patent application Ser. No. ______ (Attorney Docket No. H16.00130001), filed on even date herewith and entitled “Systems and Methods for Guided User Interface Navigation,” which claims priority to U.S. Provisional Patent Application No. 62/210,113, entitled “Method and System for Guided User Interface Navigation,” filed Aug. 26, 2015, the entirety of which are incorporated by reference herein.

### BACKGROUND

I. Technical Field

Embodiments described herein relate to personalizing and recommending content.

II. Background Art

Shared devices such as tablets, computers, and televisions (TVs) often employ methods such as user login or user profiles in order to personalize users' experiences and recommend relevant content. However, the standard user login or user profile models do not lend well to shared viewing.

### BRIEF SUMMARY

Methods, systems, and apparatuses are described for personalizing and recommending content, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a usage model system, according to an example embodiment.

FIG. 2 shows a block diagram of usage profiles, according to an example embodiment.

FIG. 3 shows a block diagram of a usage model system, according to an example embodiment.

FIG. 4 shows a flowchart for personalizing and recommending content, according to an example embodiment.

FIG. 5 shows a flowchart for personalizing and recommending content, according to an example embodiment.

FIG. 6 shows a diagram for temporal identifiers and periodicity, according to an example embodiment.

FIG. 7 shows a block diagram of a computing device/system in which the techniques disclosed herein may be performed and the embodiments herein may be utilized.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Still further, it should be noted that the drawings/figures are not drawn to scale unless otherwise noted herein.

Numerous exemplary embodiments are now described. Any section/subsection headings provided herein are not intended to be limiting. Embodiments are described throughout this document, and any type of embodiment may be included under any section/subsection. Furthermore, it is contemplated that the disclosed embodiments may be combined with each other in any manner. That is, the embodiments described herein are not mutually exclusive of each other and may be practiced and/or implemented alone, or in any combination.

### II. Example Embodiments

Systems and devices may be configured in various ways to personalize and recommend content, according to the techniques and embodiments provided.

The example techniques and embodiments described herein may be adapted to various types of systems and devices, for example but without limitation, communication devices (e.g., cellular and smart phones, etc.), computers/computing devices (e.g., laptops, tablets, desktops, etc.), computing systems, electronic devices, gaming consoles, home electronics and entertainment devices (e.g., home theater systems, stereos, televisions, etc.), and/or the like. It is contemplated herein that in various embodiments and with respect to the illustrated figures of this disclosure, one or more components described and/or shown may not be included and that additional components may be included.

The embodiments and techniques described herein allow for removing the need for user profiles or logins while providing personalization. Since viewing habits of users may frequently be periodic, an accurate content profile may be determined by using one or more temporal identifiers (IDs) such as year, month, time of day (TOD), day of week (DOW), etc., and media/multimedia activity usage patterns. Days of the month and other temporal IDs are also contemplated herein. The embodiments and techniques described herein also allow that the personalization described above may not necessarily be a single “user” profile, but rather a “usage” model that may be applicable to combinations of users in “usage” profiles. That is, a “usage” model can map to single or multiple combinations of users to “usage profiles” according to the described embodiments and techniques.

For instance, the following are non-limiting examples of “usage” profiles for a family:

Tommy.

Dad and Mom.

Sarah and Mom.

Dad and Tommy.

Dad, Mom, and Tommy.

Dad, Mom, Sarah, and Tommy.

Family.

Put another way, usage models allow for single users and combinations of different users that share similar usage of one or more devices, e.g., for viewing media/multimedia content, to be organized as a usage profile. It is contemplated herein that other groups/organizations utilizing shared devices, other than family units, may benefit according to the described embodiments and techniques.

Embodiments and techniques described herein advantageously provide a user with content recommendations at times when users are likely to be using devices for consumption of the content, and provide for content recommendations that are appropriate to groups users. That is, the usage profiles described herein allow for content recommendations based on users associated with the content as well as dates/times of content availability.

Embodiments and techniques described herein advantageously reduce the clutter of user interface (UI) elements such as graphical UI (GUI) elements presented to a user for content selection/recommendation by reducing the number of GUI elements presented to a user, thereby providing a user with a minimal, simplified GUI that automatically navigates a user through a normally cluttered, complex or confusing GUI. The reduction in clutter is possible by presenting a relatively lower number of determined recommendations based on usage profiles as described herein.

Embodiments and techniques described herein can improve the functioning of a system or a device (e.g., a computer or processing device) on which they are implemented. For example, content recommendations made according to the described techniques and embodiments allow for the simplification elements presented by a UI, e.g., a relatively small number of desired recommendations based on a usage profile. Thus, systems and devices perform more efficiently by providing content faster and using less power (less menu browsing and manual programming by the user, etc.). Additionally, the overall user experience is improved.

The described techniques and embodiments improve personalization and recommendations for content such as media and multimedia content through the use of usage modeling and usage profiles.

For instance, methods, systems, devices, and apparatuses are provided for personalizing and recommending content. A method for personalizing and recommending content implemented by a processing device in accordance with an example aspect is described. The method includes automatically detecting an activity that is participated in by one or more users, the activity comprising a media or multimedia activity, and determining a temporal identifier associated with the media or multimedia activity. The method also includes creating a usage profile for the one or more users based on the activity that was automatically detected and the temporal identifier, and storing the usage profile in a storage device.

A system in accordance with another example aspect is also described. The system includes at least one processing device, and one or more memory devices connected to the at least one processing device. The one or more memory devices are configured to store computer-executable instructions for execution by the at least one processing device. The computer-executable instructions include an observation component. The observation component is configured to automatically detect an activity that is participated in by one or more users, the activity comprising a media or multimedia activity. The observation component is also configured to determine a temporal identifier associated with the media or multimedia activity, and to create a usage profile for the one or more users based on the activity that was automatically detected and the temporal identifier. The one or more memory devices are configured to store a plurality of usage profiles including the usage profile.

A computer-readable storage medium having programmed instructions recorded thereon that, when executed by a processing device, perform a method for personalizing and recommending content in accordance with another example aspect is also described. The method includes automatically detecting an activity that is participated in by one or more users, the activity comprising a media or multimedia activity, and determining a temporal identifier associated with the media or multimedia activity. The method also includes creating a usage profile for the one or more users based on the activity that was automatically detected and the temporal identifier, and storing the usage profile in a storage device.

Various example embodiments are described in herein. In particular, example usage profile embodiments are described. This description is followed by further example embodiments and advantages. Subsequently an example processing device implementation is described. Finally, some concluding remarks are provided. It is noted that any division of the description herein generally into subsections and/or embodiments is provided for ease of illustration, and it is to be understood that any type of embodiment may be described in any subsection.

### III. Example Usage Profile Embodiments

Systems and devices may be configured in various ways to personalize and recommend content, according to the techniques and embodiments provided. As noted above, the embodiments and techniques described herein provide for “usage” models that may be applicable to combinations of users in “usage” profiles where “usage” models can map to single or multiple combinations of users in embodiments.

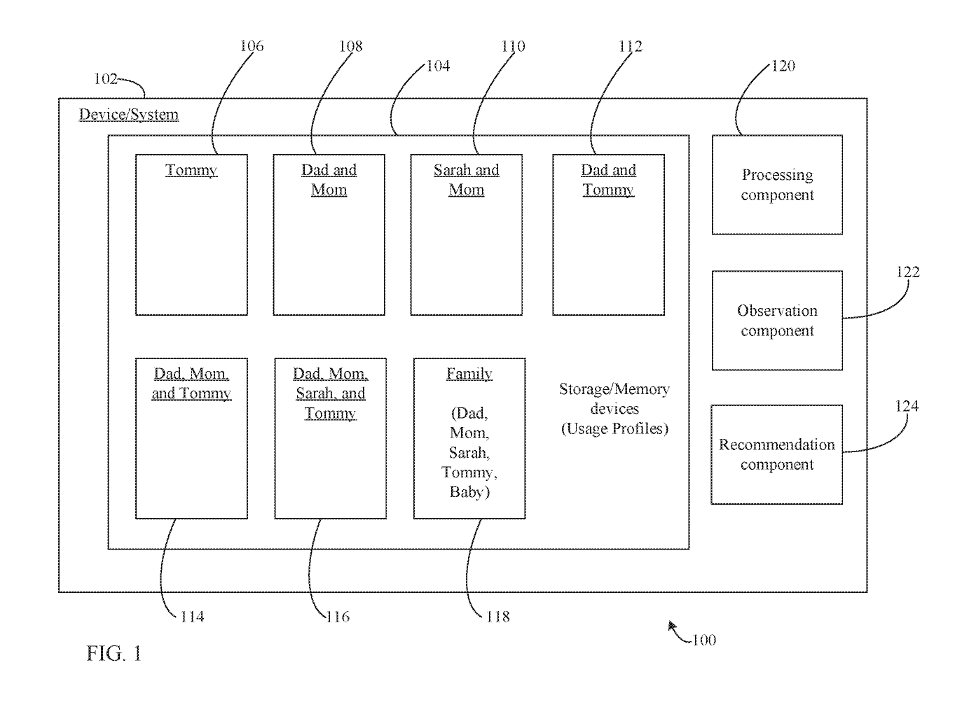

Turning now to FIG. 1, a block diagram of a usage model system 100 is shown. An example device 102 is shown in which usage profiles are stored in a storage 104. Storage 104 may be one or more of different computer-readable storage media that include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. The example usages profiles described above are shown in device 102 of usage model system 100: Tommy 106, Dad and Mom 108, Sarah and Mom 110, Dad and Tommy 112, Dad, Mom, and Tommy 114, Dad, Mom, Sarah, and Tommy 116, and Family 118. Device 102 may be any type of device disclosed herein or a portion thereof, such as, but without limitation, devices on which media and multimedia content may be consumed. For example, device 102 may be a television, a laptop, a tablet, a smart phone, a set-top box, a gaming console, a home networking device, a home entertainment device, any other in-home wireless, content-delivery/streaming devices, a custom device according to embodiments herein, etc. In embodiments, device 102 may be modularized and implemented as a system, or a portion(s) thereof, such as a client/server system. In such embodiments, one or more components of device 102 may be implemented in a server or distributed server environment (e.g., a networked server(s) or “in the cloud”), while other components may be implemented in a client-side device such as those device types described herein. Device 102 may include a hardware processing component 120 such as a central processing unit (CPU) or other type of hardware processor unit, a processing device, or other deterministic component to associate one or more temporal identifiers and/or one or more media/multimedia activities with various usage profiles according to usage models.

Device 102 may include an observation component 122 configured to observe/detect and catalog usage for a usage profile (e.g., media/multimedia activity consumption at a certain temporal ID). For instance, observation component 122 may be configured to determine that a user(s) is engaged/participating in an activity, such as a media/multimedia activity during which media/multimedia content is consumed. According to embodiments, observation component 122 may observe or detect user participation by detecting a user login to device 102 or a service associated therewith, by detecting a user login to a content provider, by facial recognition or camera(s) in a user environment, by user entry of participants via user interface (as described herein), by an identifier of one or more devices with which a participant(s) consume content (e.g., Dad's tablet, Mom's phone, etc.), by a location of one or more devices with which a participant(s) consume content (e.g., TV in Tommy's room), by a location of one or more personal devices of a participant(s), audio input and/or voice recognition, motion sensors, and/or the like. That is, a usage profile utilizes the presence and participation of one or more users, rather than a typical profile of a user. It should be noted that instances of user participation in activities and consumption of content, as described herein, may take place 1) with one or more users sharing a single device, 2) with one or more users having separate devices, 3) concurrently, and/or 4) at different times.

For example, consider a scenario in which a single user consumes content on a single device during a first temporal identifier (e.g., Dad watches a football game on his tablet in the game room on Monday night). Observation component 122 identifies/detects Dad by one or more techniques described herein and detects the content and temporal ID. Observation component 122 also identifies/detects Tommy watching a football game on the following Thursday night on TV in his room. From these detections and observations, observation component 122 is configured to create a usage profile for football content that includes the days/times football games were watched by Dad and Tommy. In addition to, or in lieu of, the observation of Tommy, observation component 122 could also identify/detect Tommy and Dad watching a football game together (sharing) at another date/time on TV in the family room.

Device 102 may include a recommendation component 124 configured to make recommendations based on the observed/detected and cataloged usage for a usage profile. That is, recommendation component 124 is configured to determine availability of released or upcoming (to be released) content to be recommended for usage profiles and/or to be recorded. Finding content for recommendations may be achieved via programming information or guides, Internet searches, periodicity of content availability, and/or the like.

Continuing the example scenario above, based on the created usage profile for Dad and Tommy watching football games, recommendation component 124 may determine when other football games are available for consumption and recommend this content, along with date/time and an indication of content provider. In embodiments, recommendation component 124 may also recommend football game content (e.g., by providing selectable elements via a UI, automatically changing to a corresponding channel, etc.) when the presence/participation of Dad and/or Tommy is detected or observed, as described herein.

Additionally, similar content that is already available or that will become available, may be recorded, e.g., automatically, when available and recommended to one or more users in the usage profile.

In some embodiments, observation component 122 and/or recommendation component 124 may be included in hardware processing component 120, or may be implemented as executable instructions by hardware processing component 120.

According to embodiments and as noted above, e.g., for media/multimedia consumption, one or more temporal identifiers such as a certain time of the year, TODs, and/or DOWs may be associated with different usage profiles similarly as exemplified above. Likewise, one or more media/multimedia activities may be associated with different usage profiles. For instance, the following are non-limiting examples of usage profiles associated with temporal identifiers (e.g., certain times of the year, TODs, and/or DOWs) and media/multimedia activities according to a usage model:

Tommy often plays video games on weekday mornings before school.

Dad often watches the local news on TV after breakfast.

Sarah and Mom watch a specific TV show every Thursday night.

Dad watches late night TV.

Dad and Tommy watch football on Monday, Thursday, Saturday, and/or Sunday.

Dad, Mom, Sarah and Tommy watch a movie on Saturday night.

Family watches The Super Bowl™.

Sarah watches the Olympics every four years.

Mom listens to audio content on a music channel.

It should be noted that one or more observations or detections may be made that do not track a periodic schedule. For example, as shown above, “Tommy often plays video games on weekday mornings before school” may be an example usage profile. Device 102 may observe and detect repeated instances of activity participation and content consumption that do not conform to patterns. As another example, “Mom listens to audio content on a music channel” may indicate that Mom is observed consuming content at multiple instances of temporal IDs, but without definite patterns (e.g., at least 4 days per week, but not on set days or at set times). In such cases, usage profiles and recommended content may reflect dates/times and periodicity that is approximate to the actual consumption, or that reflects a periodic consumption in which the actual consumption fits as a portion thereof.

Turning now to FIG. 2, example usage profiles 200 are shown. Specifically, by way of example and not limitation, usage profile Tommy 106 and usage profile Sarah and Mom 110 of FIG. 1 are shown with example elements. For example, Tommy 106 includes a user field 202 (Tommy), a temporal ID field 204 (mornings before school), and an activity field 206 (video games). Similarly, Sarah and Mom 110 includes a user field 208 (Sarah and Mom), a temporal ID field 210 (Thursday nights, weekly), and an activity field 212 (specific TV show). These usage profiles may be created and/or modified according to usage models, as described herein, e.g., by usage profile system 100 of FIG. 1.

Based on one or more (e.g., repeated) observations of usage profiles, temporal identifiers, and media/multimedia activities, e.g., by observation component 122 of FIG. 1, the embodiments and techniques described may recommend relevant content, e.g., by recommendation component 124 of FIG. 1. In embodiments, usage model system 100 (e.g., via recommendation component 124) may, in addition to recommending content, queue the recommended content for consumption by a member(s) of a usage profile. For example, usage model system 100 may automatically tune the TV to content that a member(s) of a usage profile is/are likely to watch based on the above-described observations and recommendations, according to embodiments. Similarly, usage model system 100 may automatically load up a video game that a member(s) of a usage profile is/are likely to want to play. Usage model system 100 may automatically record content using a digital video recorder (DVR) or other recording device/medium, and may add content to a list of recommended content for usage profiles. Additionally, usage model system 100 may be configured to cause, automatically or by user input, media/multimedia content (e.g., physical media such as DVDs, etc.) to be sent to a specified location associated with a usage profile (e.g., a delivery service to a house of a family), and/or may be configured to cause, automatically or by user input, media/multimedia content to be streamed by a content provider over a network such as the Internet.

In other words, when usage model system 100 detects consumed content shared by, i.e., activities participated in by, users at temporal identifiers, usage model system 100 is configured to create a usage profile and automatically recommend additional content where content recommendations are personalized through the usage models. For instance, new episodes for television content (e.g., via content providers) may be recommended based on past viewing/consumption observations for a usage profile. Recommendations may comprise new shows that will become available for the television content or that will be recorded (or have been recorded) based on periodicity of the television content. Recommended content may be associated with, or related to, content of the same or a similar genre as content of a usage profile that was consumed.

It is also contemplated herein that recommendations for a usage profile may be made for sequels, items of content in a series, and timed events related to, similar to, and/or associated with various forms of media/multimedia content that are consumed.

In embodiments, recommendations may be made based on any combination of a usage profile, indications (e.g., “like” tags) of preferences for users, and/or a new event(s) that happens or new content that is provided (e.g., based on periodic events/content or based on a new event or a release of new content).

Additionally, usage model system 100 may be configured to generate a user interface (UI) that provides a member(s) of a usage profile with the recommendation and also with options for viewing/playing/listening to the recommended content.

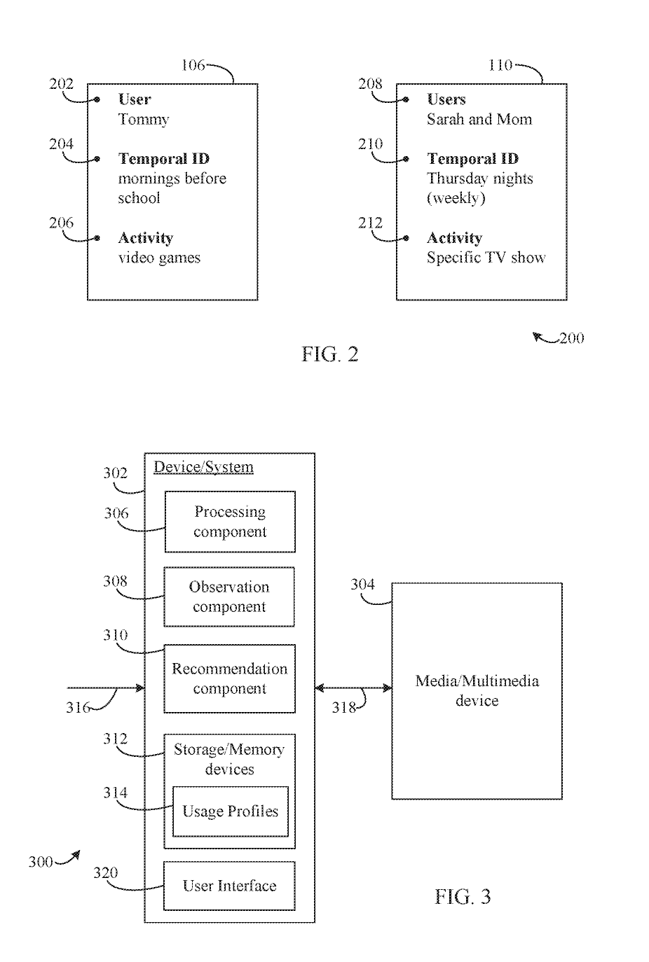

For example, turning now to FIG. 3, a block diagram of a usage model system 300 is shown. Usage model system 300 may be a further embodiment of usage model system 100 of FIG. 1. A media/multimedia device 304 and an example device 302 in which usage profiles 314 (e.g., any type of usage profile described herein) are stored in a storage 312 are shown in usage model system 300. Device 302 may be a system or a device in embodiments, and may be a further embodiment of device 102 of FIG. 1, while storage 312 may be a further embodiment of storage 104 of FIG. 1. Device 302 includes a hardware processing component 306 such as a processor unit, a processing device, or other deterministic component to associate one or more temporal identifiers and/or one or more media/multimedia activities with various usage profiles according to usage models, and which may be a further embodiment of hardware processing component 120 of FIG. 1. Device 302 includes an observation component 308 configured to observe/detect and catalog usage for a usage profile (e.g., media/multimedia activity consumption at a certain temporal ID) that may be a further embodiment of observation component 122 of FIG. 1. Device 302 includes a recommendation component 310 configured to make recommendations based on the observed/detected and cataloged usage for a usage profile, and that may be a further embodiment of recommendation component 124 of FIG. 1.

In some embodiments, observation component 308 and/or recommendation component 310 may be included in hardware processing component 306, or may be implemented as executable instructions by hardware processing component 306.

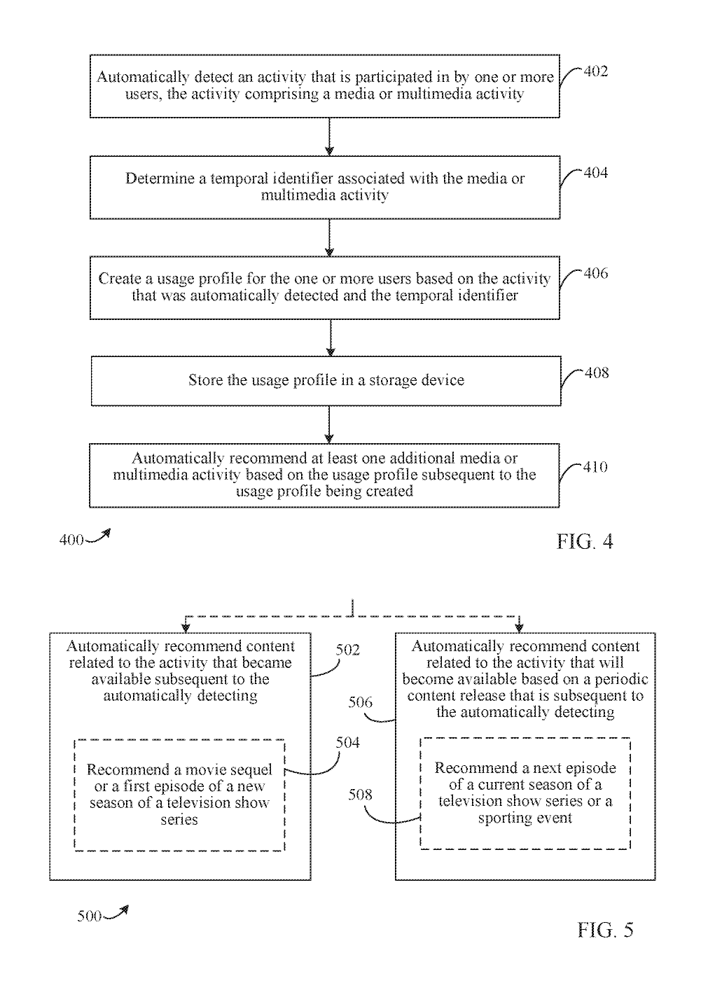

FIGS. 4 and 5 show operational embodiments of the systems and devices described herein. Turning now to FIG. 4, a flowchart 400 having steps for recommending and personalization of content is shown, according to an embodiment. Usage model system 100 and usage model system 300, along with any respective components/subcomponents thereof such as device 102 and/or device 302, are configured to perform their respective functions in accordance with flowchart 400, in embodiments. Flowchart 400 is described as follows.

An activity that is participated in by one or more users is automatically detected, the activity comprising a media or multimedia activity (402). For example, device 302 is configured to receive media or multimedia content, or indicia thereof (hereinafter, “content”), via a content input connection 316 (that may be wired or wireless) that may be consumed by one or more users as a media or multimedia activity. Device 302, e.g., via observation component 308, may observe or detect that one or more users consume, or are associated with consuming, a media activity or a multimedia activity related to the received content, as described herein with respect to observation component 122 of FIG. 1 (e.g., observe/detect user participation by detecting a user login to device 302 or a service associated therewith, by detecting a user login to a content provider, by facial recognition or camera(s) in a user environment, by user entry of participants via user interface (as described herein), by an identifier of one or more devices with which a participant(s) consume content (e.g., Dad's tablet, Mom's phone, etc.), by a location of one or more devices with which a participant(s) consume content (e.g., TV in Tommy's room), by a location of one or more personal devices of a participant(s), audio input and/or vocal recognition, motion/kinetic sensors, and/or the like). That is, a usage profile utilizes the presence and participation of one or more users, rather than a typical profile of a user. A media or multimedia activity may include, without limitation, consuming one or more of a television show, music, a movie, a video, a video game, a podcast, a television event, a recording, streaming media or multimedia content, social media content, web content, and/or the like.

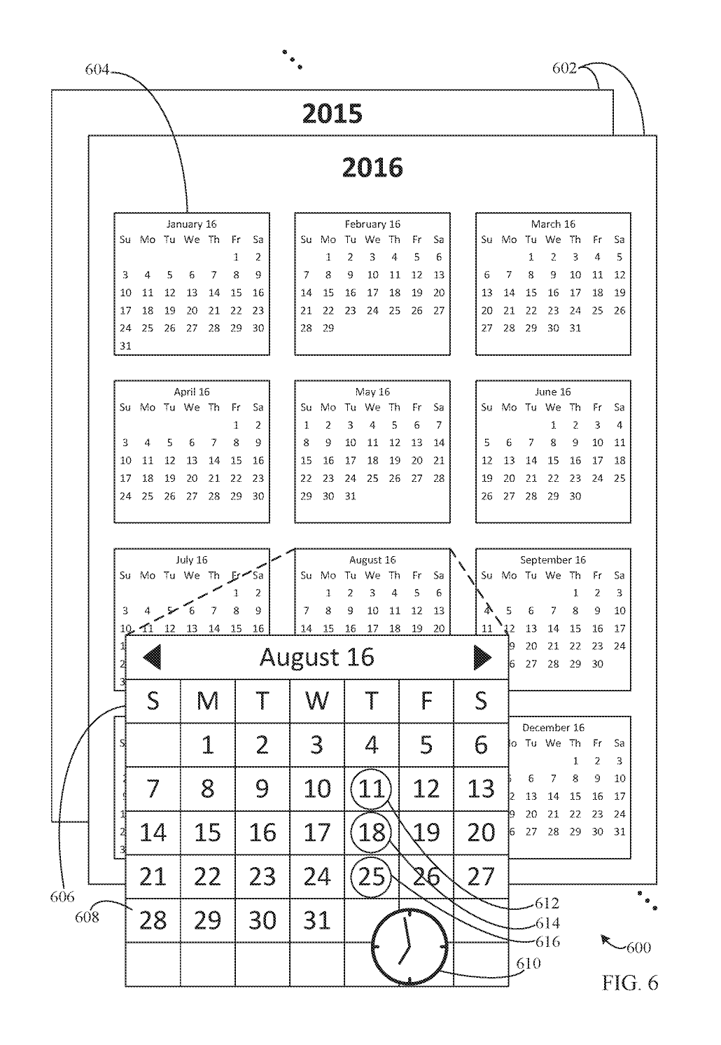

A temporal identifier associated with the media or multimedia activity is determined (404). For instance, device 302, e.g., via observation component 308, is configured to determine or observe a temporal identifier associated with the received content consumed in (402). Observation component 308 may determine/observe the temporal identifier via information, such as programming information, received with the content, via a digital calendar as described below with respect to FIG. 6, and/or the like.

A usage profile for the one or more users is created based on the activity that was automatically detected and the temporal identifier (406). For example, device 302, e.g., via observation component 308, is configured to create usage profiles. These usage profiles may be automatically created based on one or more observations/detections of a user(s) consuming media/multimedia content (402) and on temporal identifiers associated with the content (404). Created profiles may also be updated based on additional observations/detections, additional/fewer users consuming content, changes in temporal identifiers, the release of new content, etc.

The usage profile is stored in a storage device (408). For instance, device 302, e.g., via storage 312 described herein, is configured to store usage profiles that are created and/or updated by observation component (and/or by recommendation component 310).

Based on the usage profile, device 302 is configured to recommend additional content.

At least one additional media or multimedia activity is automatically recommended based on the usage profile subsequent to the usage profile being created (410). For example, device 302, e.g., via recommendation component 310, is configured to automatically recommend additional content based on the usage profile after the usage profile is created.

As noted above, recommended content may be associated with, or related to, content of a usage profile that was consumed, such as, but without limitation, episodes in a series of content, sequels, periodic events, content of the same or a similar genre, etc.

For instance, FIG. 5 shows a flowchart 400 having steps for recommending and personalization of content, according to an embodiment. Usage model system 100 and usage model system 300, along with any respective components/subcomponents thereof such as device 102 and/or device 302, are configured to perform their respective functions in accordance with flowchart 500, in embodiments. Flowchart 500 may be a further embodiment of one or more portions of flowchart 400, such as step 410. Flowchart 500 is described as follows.

Content related to the activity that became available subsequent to the automatically detecting is automatically recommended (502). For instance, recommendation component 310 is configured to recommend content that became available after the content of the activity (402) was consumed. A movie sequel or a first episode of a new season of a television show series may be recommended (504). The recommended content may be content that is not provided or released periodically. In embodiments, step (504) may not be included.

Content related to the activity that will become available based on a periodic content release that is subsequent to the automatically detecting is automatically recommended (506). For example, recommendation component 310 is configured to recommend content related to the activity (402) that will become available based on a periodic content release. A next episode of a current season of a television show series or a sporting event may be recommended (508). The recommended content may be content that is provided or released periodically. In embodiments, step (508) may not be included.

As described herein, periodicity includes time periods based on any described temporal identifier, such as, but not limited to, hourly, daily, weekly, monthly, quarterly, yearly, every two, three, or four years, etc., such as other time periods described herein. For instance, turning now to FIG. 6, a diagram for temporal identifiers and periodicity is shown, according to an embodiment. FIG. 6 shows a digital calendar 600. Calendar 600 includes years 602, months 604, weeks 606, days 608, and time of day (a clock 610).

Referring again to FIG. 2, by way of example, usage profile Sarah and Mom 110 includes a user field 208 (Sarah and Mom), a temporal ID field 210 (Thursday nights, weekly), and an activity field 212 (specific TV show). In an example scenario, if usage profile Sarah and Mom 110 was created by an observation/detection of Sarah and Mom consuming the specified TV show during nights of first day 612 and of second day 614, then by using periodicity, recommendation component 310 may also recommend the specified TV show during the night of third day 616. Additionally, or alternatively, recommendation component 310 may detect or observe that Sarah and/or Mom are present and participating in consuming content at night on second day 614 after being observed consuming the specified TV show during nights of first day 612. Based on detecting or observing Sarah and/or Mom on second day 614, recommendation component 310 may also recommend the specified TV show on second day 614. Still further, recommendation component 310 may recommend a recording of the specified TV show when Sarah and/or Mom are detected or observed consuming content.

In some cases, different usage profiles may have overlapping or conflicting temporal IDs for different content and/or different groups of users. For instance, in the context of the current example for “usage profile Sarah and Mom 110” and the example scenario described with respect to FIG. 1 in Section III for “usage profile for Dad and Tommy watching football games,” each of these usage profiles includes content that may be consumed on a Thursday night. Observation component 308 may observe or detect the presence or participation of users, as described herein, and based on the presence or participation, recommendation component 310 recommends the appropriate content. For example, if Tommy or Dad is present/participating, football game content may be recommended, while if Sarah or Mom are present/participating, the specified TV show may be recommended. If a user(s) from each usage profile is present, each content may be presented. If more users of a first usage profile are present/participating than a second conflicting usage profile, content associated with the first usage profile may be prioritized for recommendation.

While days in weekly periodicity are used in the example scenario above, the embodiments herein are not so limited and contemplate other periods as described herein. Furthermore, temporal identifiers, as described herein, may include specific times (e.g., 9:00 pm) or general/approximate times (Thursday night, Monday morning, etc.). Additionally, periodicity, with respect to media/multimedia content and activities, may be approximate or may be exact, in embodiments. For instance, due to scheduling, leap years, etc., periodic programming may take place according to an approximate period (e.g., the Super Bowl™ may not always be played on the same day at the same time each year).

Referring again to device 302 of FIG. 3, device 302 includes a user interface (UI) 320 configured to provide a member(s) of a usage profile with recommendations and also with options for viewing/playing/listening to the recommended content, according to embodiments. UI 320 may be a graphical UI (GUI) according to embodiments. In embodiments, UI 320 is configured to receive user inputs related to selection of recommended content and/or indicia of user preferences. UI 320 may be comprised of hardware, software, firmware, or any combination thereof. For example, UI 320 may include a display (e.g., a display screen, a touch screen, etc.), a wired or wireless remote controller, an application on a user device such as a smartphone, tablet, etc., a computer network interface on a laptop or personal computer, and/or audio input/output. In embodiments, UI 320 is configured to provide outputs to and receive inputs from media/multimedia device 304 (that may include a display, audio input/output, and/or other UI features) via a connection 318 that may be wired or wireless.

According to the techniques and embodiments herein, content recommendations made by device 302 (e.g., via recommendation component 310) allow for the simplification of UI 320 and/or of information presented thereby. For example, a relatively small number of desired recommendations based on a usage profile (e.g., 1, 2, or 3, a fraction or portion of a list of recommendations, etc.) may be displayed and/or presented via UI 320. Thus, device 302 performs more efficiently by providing content faster and with less processing, and by using less power. Additionally, the overall user experience is improved.

Device 302 may be any type of device disclosed herein. For example, device 302 may be a television, a laptop, a tablet, a smart phone, a set-top box, a gaming console, a home networking device, a home entertainment device, any other in-home wireless, content-delivery/streaming devices, a custom device according to embodiments herein, etc. Device 302 may also comprise a portion of a system or another device such as a set-top box or others described herein, or may be a stand-alone device with content signal feedthrough or other inputs. In embodiments, device 302 may be modularized and implemented as a system, or a portion(s) thereof, such as a client/server system. In such embodiments, one or more components of device 102 may be implemented in a server or distributed server environment (e.g., a networked server(s) or “in the cloud”), while other components may be implemented in a client-side device such as those device types described herein.

It is also contemplated herein that observation component 308 and recommendation component 310 may provide each other with their respective information as feedback for updating observations and recommendations by usage model system 300 and/or device 302.

### IV. Further Example Embodiments and Advantages

It should be noted that embodiments are contemplated for different types of media and multimedia content and activities, and while some embodiments described above refer to television content, embodiments are not so limited. Embodiments contemplate, without limitation, all forms of streaming media and multimedia content, rentable and pay-per-view content, content from satellite providers, content from internet service/application providers, and/or the like.

In embodiments, one or more of the operations of any flowchart described herein may not be performed. Moreover, operations in addition to or in lieu of any flowchart described herein may be performed. Further, in embodiments, one or more operations of any flowchart described herein may be performed out of order, in an alternate sequence, or partially (or completely) concurrently with each other or with any other operations.

As noted above, systems and devices may be configured in various ways to personalize and recommend content, according to the techniques and embodiments provided. For example, embodiments and techniques, including methods, described herein may be performed in various ways such as, but not limited to, being implemented by hardware, or hardware combined with one or both of software and firmware. For example, embodiments may be implemented as systems and devices, such as usage model systems and devices, specifically customized hardware, ASICs, electrical circuitry, and/or the like.

The further example embodiments and advantages described in this Section may be applicable to embodiments disclosed in any other Section of this disclosure.

### V. Example Computer Implementations

Various features of usage model system 100 of FIG. 1, usage profiles 200 of FIG. 2, usage model system 300 of FIG. 3, along with various features of any respective components/subcomponents thereof, and/or any techniques, flowcharts, further systems, sub-systems, and/or components disclosed and contemplated herein may be implemented in hardware (e.g., hardware logic/electrical circuitry), or any combination of hardware with one or both of software (computer program code or instructions configured to be executed in one or more processors or processing devices) and firmware.

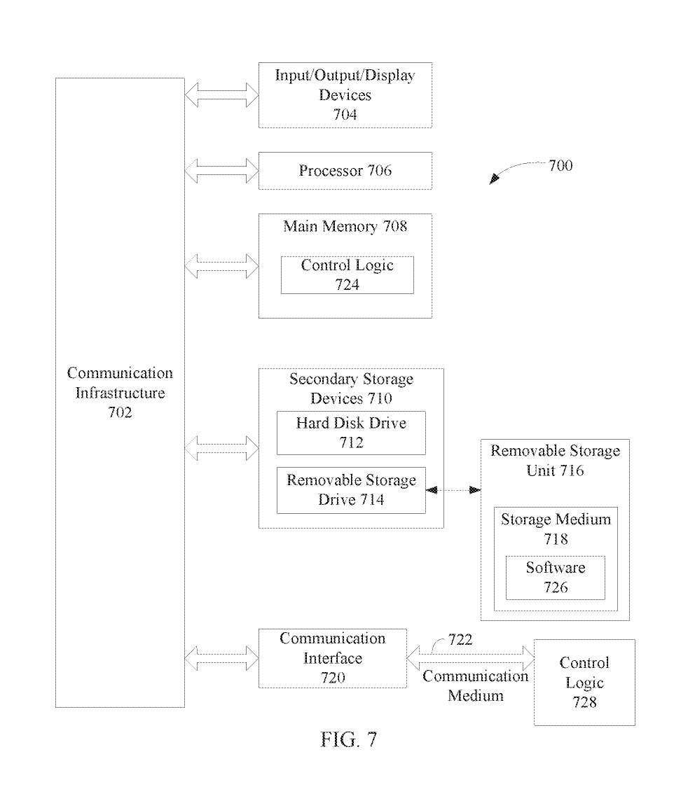

The embodiments described herein, including circuitry, devices, systems, methods/processes, and/or apparatuses, may be implemented in or using well known processing devices, communication systems, servers, and/or, computers, such as a processing device 700 shown in FIG. 7. It should be noted that processing device 700 may represent communication devices/systems, entertainment systems/devices, processing devices, as well as tablets, laptops and/or traditional computers in one or more embodiments. For example, usage model systems and shared devices according to the described techniques and embodiments, and any of the sub-systems and/or components respectively contained therein and/or associated therewith, may be implemented in or using one or more processing devices 700 and similar computing devices.

Processing device 700 can be any commercially available and well known communication device, processing device, and/or computer capable of performing the functions described herein, such as, but not limited to, devices/computers available from International Business Machines®, Apple®, Sun®, HP®, Dell®, Cray®, Samsung®, Nokia®, etc. Processing device 700 may be any type of computer, including a desktop computer, a server, etc., and may be a computing device or system within another device or system.

Processing device 700 includes one or more processors (also called central processing units, or CPUs), such as a processor 706. Processor 706 is connected to a communication infrastructure 702, such as a communication bus. In some embodiments, processor 706 can simultaneously operate multiple computing threads, and in some embodiments, processor 706 may comprise one or more processors.

Processing device 700 also includes a primary or main memory 708, such as random access memory (RAM). Main memory 708 has stored therein control logic 724 (computer software), and data.

Processing device 700 also includes one or more secondary storage devices 710. Secondary storage devices 710 include, for example, a hard disk drive 712 and/or a removable storage device or drive 714, as well as other types of storage devices, such as memory cards and memory sticks. For instance, processing device 700 may include an industry standard interface, such a universal serial bus (USB) interface for interfacing with devices such as a memory stick. Removable storage drive 714 represents a floppy disk drive, a magnetic tape drive, a compact disk drive, an optical storage device, tape backup, etc.

Removable storage drive 714 may interact with a removable storage unit 716. Removable storage unit 716 includes a computer useable or readable storage medium 718 having stored therein computer software 726 (control logic) and/or data. Removable storage unit 716 represents a floppy disk, magnetic tape, compact disk, DVD, optical storage disk, or any other computer data storage device. Removable storage drive 714 reads from and/or writes to removable storage unit 716 in a well-known manner.

Processing device 700 also includes input/output/display devices 704, such as touchscreens, LED and LCD displays, monitors, keyboards, pointing devices, etc.

Processing device 700 further includes a communication or network interface 720. Communication interface 720 enables processing device 700 to communicate with remote devices. For example, communication interface 720 allows processing device 700 to communicate over communication networks or mediums 722 (representing a form of a computer useable or readable medium), such as LANs, WANs, the Internet, etc. Communication interface 720 may interface with remote sites or networks via wired or wireless connections.

Control logic 728 may be transmitted to and from processing device 700 via the communication medium 722.

Any apparatus or manufacture comprising a computer useable or readable medium having control logic (software) stored therein is referred to herein as a computer program product or program storage device. This includes, but is not limited to, processing device 700, main memory 708, secondary storage devices 710, and removable storage unit 716. Such computer program products, having control logic stored therein that, when executed by one or more data processing devices, cause such data processing devices to operate as described herein, represent embodiments.

Techniques, including methods, and embodiments described herein may be implemented by hardware (digital and/or analog) or a combination of hardware with one or both of software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed by one or more processor circuits, causes a device to operate as described herein. Devices in which embodiments may be implemented may include storage, such as storage drives, memory devices, and further types of physical hardware computer-readable storage media. Examples of such computer-readable storage media include, a hard disk, a removable magnetic disk, a removable optical disk, flash memory cards, digital video disks, random access memories (RAMs), read only memories (ROM), and other types of physical hardware storage media. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. Such computer-readable storage media may, for example, store computer program logic, e.g., program modules, comprising computer executable instructions that, when executed by one or more processor circuits, provide and/or maintain one or more aspects of functionality described herein with reference to the figures, as well as any and all components, capabilities, and functions therein and/or further embodiments described herein.

Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media and signals transmitted over wired media. Embodiments are also directed to such communication media.

The techniques and embodiments described herein may be implemented as, or in, various types of devices. For instance, embodiments may be included, without limitation, in processing devices (e.g., illustrated in FIG. 7) such as computers and servers, as well as communication systems such as switches, routers, gateways, and/or the like, communication devices such as smart phones, home electronics, gaming consoles, entertainment devices/systems, etc. A device, as defined herein, is a machine or manufacture as defined by 35 U.S.C. §101. That is, as used herein, the term “device” refers to a machine or other tangible, manufactured object and excludes software and signals. Devices may include digital circuits, analog circuits, or a combination thereof. Devices may include one or more processor circuits (e.g., central processing units (CPUs), processor 706 of FIG. 7), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### VI. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method for personalizing and recommending content implemented by a processing device, comprising:
automatically detecting an activity that is participated in by one or more users, the activity comprising a media or multimedia activity;
determining a temporal identifier associated with the media or multimedia activity;
creating a usage profile for the one or more users based on the activity that was automatically detected and the temporal identifier; and
storing the usage profile in a storage device.

2. The method of claim 1, wherein the automatically detecting takes place over two or more occurrences of the activity.

3. The method of claim 1, further comprising:
automatically recommending at least one additional media or multimedia activity based on the usage profile subsequent to the usage profile being created.

4. The method of claim 3, wherein the at least one additional media or multimedia activity comprises one or more of:
content related to the activity that became available subsequent to the automatically detecting; or
content related to the activity that will become available based on a periodic content release that is subsequent to the automatically detecting.

5. The method of claim 4, wherein the content related to the activity that became available subsequent to the automatically detecting comprises a movie sequel or a first episode of a new season of a television show series; or
wherein the content related to the activity that will become available based on a periodic content release that is subsequent to the automatically detecting comprises a next episode of a current season of a television show series or a sporting event.

6. The method of claim 1, wherein the media or multimedia activity includes consuming one or more of a television show, music, a movie, a video, a video game, a podcast, a television event, a recording, streaming media or multimedia content, social media content, or web content.

7. The method of claim 1, wherein the temporal identifier includes one or more of a time of year, a time of year of non-consecutive years, a month, a day of the month, a week, a day of the week, a day of the year, or a time of day.

8. A system comprising:
at least one processing device; and
one or more memory devices connected to the at least one processing device, the one or more memory devices being configured to store computer-executable instructions for execution by the at least one processing device, the computer-executable instructions including:
an observation component configured to:
automatically detect an activity that is participated in by one or more users, the activity comprising a media or multimedia activity;
determine a temporal identifier associated with the media or multimedia activity; and
create a usage profile for the one or more users based on the activity that was automatically detected and the temporal identifier; and
wherein the one or more memory devices are configured to store a plurality of usage profiles including the usage profile.

9. The system of claim 8, wherein the observation component is configured to perform at least one of said automatically detect the activity or said determine the temporal identifier at a plurality of times for one or more of different sets of users, different activities that are participated in by one or more users, or different temporal identifiers to create a plurality of usage profiles.

10. The system of claim 8, wherein the observation component is configured to automatically detect over two or more occurrences of the activity.

11. The system of claim 8, further comprising:
a recommendation component configured to automatically recommend at least one additional media or multimedia activity based on the usage profile.

12. The system of claim 11, wherein the at least one additional media or multimedia activity comprises one or more of:
content related to the activity that became available subsequent to the automatically detecting; or
content related to the activity that will become available based on a periodic content release that is subsequent to the automatically detecting.

13. The system of claim 12, wherein the content related to the activity that became available subsequent to the automatically detecting comprises a movie sequel or a first episode of a new season of a television show series; or
wherein the content related to the activity that will become available based on a periodic content release that is subsequent to the automatically detecting comprises a next episode of a current season of a television show series or a sporting event.

14. The system of claim 8, wherein the media or multimedia activity includes consuming one or more of a television show, music, a movie, a video, a video game, a podcast, a television event, a recording, streaming media or multimedia content, social media content, or web content.

15. The system of claim 8, wherein the temporal identifier includes one or more of a time of year, a time of year of non-consecutive years, a month, a day of the month, a week, a day of the week, a day of the year, or a time of day.

16. A computer-readable storage medium having programmed instructions recorded thereon that, when executed by a processing device, perform a method for personalizing and recommending content, the method comprising:
automatically detecting an activity that is participated in by one or more users, the activity comprising a media or multimedia activity;
determining a temporal identifier associated with the media or multimedia activity;
creating a usage profile for the one or more users based on the activity that was automatically detected and the temporal identifier; and
storing the usage profile in a storage device.

17. The computer-readable storage medium of claim 16, wherein the automatically detecting takes place over two or more occurrences of the activity.

18. The computer-readable storage medium of claim 16, the method further comprising:
automatically recommending at least one additional media or multimedia activity based on the usage profile subsequent to the usage profile being created.

19. The computer-readable storage medium of claim 18, wherein the at least one additional media or multimedia activity comprises one or more of:
content related to the activity that became available subsequent to the automatically detecting; and
content related to the activity that will become available based on a periodic content release that is subsequent to the automatically detecting.

20. The computer-readable storage medium of claim 19, wherein at least one of:
the content related to the activity that became available subsequent to the automatically detecting comprises a movie sequel or a first episode of a new season of a television show series;
the content related to the activity that will become available based on a periodic content release that is subsequent to the automatically detecting comprises a next episode of a current season of a television show series or a sporting event;
the media or multimedia activity includes consuming one or more of a television show, music, a movie, a video, a video game, a podcast, a television event, a recording, streaming media or multimedia content, social media content, or web content; or
the temporal identifier includes one or more of a time of year, a time of year of non-consecutive years, a month, a day of the month, a week, a day of the week, a day of the year, or a time of day.
